(19) United States
(12) Patent Application Publication
(10) Pub. No.: US 2019/0391471 A1
(43) Pub. Date: Dec. 26, 2019

(54) ILLUMINATING SYSTEM AND PROJECTING APPARATUS

(71) Applicant: Coretronic Corporation, Hsin-Chu (TW)

(72) Inventor: Yi-Hsuang Weng, Hsin-Chu (TW)

(73) Assignee: Coretronic Corporation, Hsin-Chu (TW)

(21) Appl. No.: 16/445,220

(22) Filed: Jun. 19, 2019

(30) Foreign Application Priority Data
Jun. 20, 2018 (CN) 201810634190.0

(51) Int. Cl. G03B 21/20; G02B 26/00

(52) U.S. Cl. CPC G03B 21/204; G02B 26/008; G03B 21/2066; G03B 21/208

(57) ABSTRACT

An illuminating system and a projecting apparatus are provided. A first light emitting module emits an exciting beam. A wavelength conversion device has a wavelength conversion region and a reflection region, wherein the wavelength conversion region converts the exciting beam into a converted beam with a larger wavelength. A spherical-shell-shaped dichroic device located between a first light emitting module and the wavelength conversion device allows the exciting beam to penetrate and reflects the converted beam, wherein the reflected converted beam converges on a light incident surface of a light homogenizing device. The reflected exciting beam penetrates the spherical-shell-shaped dichroic device to a light relay unit, and the light relay unit reflects the exciting beam such that the exciting beam re-penetrates the spherical-shell-shaped dichroic device and converges on the light incident surface. The exciting beam and the converted beam pass through the light homogenizing device to form an illuminating beam.

### CROSS-REFERENCE TO RELATED APPLICATION

This application claims the priority benefit of China application Ser. No. 201810634190.0, filed on Jun. 20, 2018. The entirety of the above-mentioned patent application is hereby incorporated by reference herein and made a part of this specification.

### BACKGROUND OF THE INVENTION

### 1. Field of the Invention

The present invention relates to an illuminating system and a projecting apparatus, in particular to an illuminating system and a projecting apparatus having a simple structure.

### 2. Description of Related Art

Generally, a blue laser module is generally provided as a light source module of a laser projector to provide continuous blue light, and a part of blue laser light is irradiated on a rotating phosphor wheel to excite other colored light, for example, blue laser light is irradiated onto yellow phosphor to produce a yellow beam. A general light source module laser combiner structure needs to provide an additional light beam transmission path for the blue laser light so that the overall structure of the laser combiner is too large and the volume is not easily reduced.

In addition, the general laser combiner uses a reflective device to collect other colored light excited from the phosphor wheel. Thus, there may be an opening or a dichroic mirror on the reflective device to allow blue light to pass, but it will cause partial beam loss and lower the system efficiency of the projector.

The information disclosed in this “BACKGROUND OF THE INVENTION” section is only for enhancement of understanding of the background of the described technology and therefore it may contain information that does not form the prior art that is already known to a person of ordinary skill in the art. Further, the information disclosed in this “BACKGROUND OF THE INVENTION” section does not mean that one or more problems to be resolved by one or more embodiments of the invention were acknowledged by a person of ordinary skill in the art.

### SUMMARY OF THE INVENTION

The embodiments of the present invention provide an illuminating system and a projecting apparatus, having a simple structure and higher system efficiency.

Other objectives and advantages of the present invention may be further understood from the technical features disclosed in the present invention.

In order to achieve one, some, or all of the aforementioned objectives or other objectives, an embodiment of the present invention provides an illuminating system. The illuminating system includes a first light emitting module, a wavelength conversion device, a spherical-shell-shaped dichroic device, a light homogenizing device, and a light relay unit. The first light emitting module is configured to emit an exciting beam. The wavelength conversion device is disposed on a transmission path of the exciting beam, and has a wavelength conversion region and a reflection region, wherein the wavelength conversion region is configured to convert the exciting beam into a converted beam, wherein a wavelength of the converted beam is greater than a wavelength of the exciting beam, and the reflection region is configured to reflect the exciting beam. The spherical-shell-shaped dichroic device is located between the first light emitting module and the wavelength conversion device, and the spherical-shell-shaped dichroic device is configured to allow the exciting beam to penetrate and to reflect the converted beam. The light homogenizing device is disposed on one side of the spherical-shell-shaped dichroic device together with the wavelength conversion device relative to the first light emitting module, and the light homogenizing device has a light incident surface, wherein the converted beam reflected by the spherical-shell-shaped dichroic device converges on the light incident surface. Based on an optical axis of the spherical-shell-shaped dichroic device, the light relay unit and the first light emitting module are respectively disposed on two sides of an outer side of the spherical-shell-shaped dichroic device, wherein the exciting beam reflected by the wavelength conversion device penetrates the spherical-shell-shaped dichroic device and is transmitted to the light relay unit, and the light relay unit reflects the exciting beam such that the exciting beam re-penetrates the spherical-shell-shaped dichroic device and converges on the light incident surface of the light homogenizing device, wherein the exciting beam and the converted beam pass through the light homogenizing device to form an illuminating beam.

In order to achieve one, some, or all of the aforementioned objectives or other objectives, an embodiment of the present invention provides a projecting apparatus, which includes an illuminating system, including the above-mentioned illuminating system, a filter device, a light valve module and an imaging lens. The light valve module is disposed on a transmission path of an illuminating beam, and respectively converts the illuminating beam into at least one image beam. The imaging lens is disposed on a transmission path of at least one image beam, and the at least one image beam is transmitted to the imaging lens to form a projecting beam.

Based on the above, the illuminating system and the projecting apparatus according to the embodiments of the present invention have the advantages of simple structure and lowered manufacturing cost, and thus may reduce the structure volume and are easily combined with an optical lens system.

In order to make the aforementioned and other objectives and advantages of the present invention comprehensible, embodiments accompanied with figures are described in detail below.

### BRIEF DESCRIPTION OF THE DRAWINGS

FIG. 1A is a block diagram of a projecting apparatus according to an embodiment of the present invention.

FIG. 1B is a diagram of an illuminating system according to an embodiment of the present invention.

FIG. 2A is a diagram of reflectance of a spherical-shell-shaped dichroic device versus incident wavelengths according to an embodiment of the present invention.

FIG. 2B to FIG. 2C are diagrams of reflectance of a light relay unit versus incident wavelengths according to an embodiment of the present invention.

FIG. 3 is a diagram of a wavelength conversion device according to an embodiment of the present invention.

FIG. 4A is a diagram of an illuminating system according to another embodiment of the present invention.

FIG. 4B is a diagram of an illuminating system according to another embodiment of the present invention.

FIG. 5 is a diagram of an illuminating system according to another embodiment of the present invention.

FIG. 6A is a diagram of an illuminating system according to another embodiment of the present invention.

FIG. 6B is a diagram of an illuminating system according to another embodiment of the present invention.

FIG. 7 is a diagram of an illuminating system according to another embodiment of the present invention.

FIG. 8A is a diagram of an illuminating system according to another embodiment of the present invention.

FIG. 8B is a diagram of a wavelength conversion device according to another embodiment of the present invention.

FIG. 8C is a diagram of a filter device of FIG. 8A according to the present invention.

FIG. 9A is a diagram of an illuminating system according to another embodiment of the present invention.

FIG. 9B is a diagram of a filter device according to FIG. 9A of the present invention.

FIG. 10A is a diagram of an illuminating system according to another embodiment of the present invention.

FIG. 10B is a diagram of reflectance of a spherical-shell-shaped dichroic device of FIG. 10A versus incident wavelengths according to the present invention.

FIG. 11A is an incidence beam sequence diagram for a wavelength conversion device and a filter device of FIG. 10A according to the present invention.

FIG. 11B is another incidence beam sequence diagram for the wavelength conversion device and the filter device of FIG. 10A according to the present invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

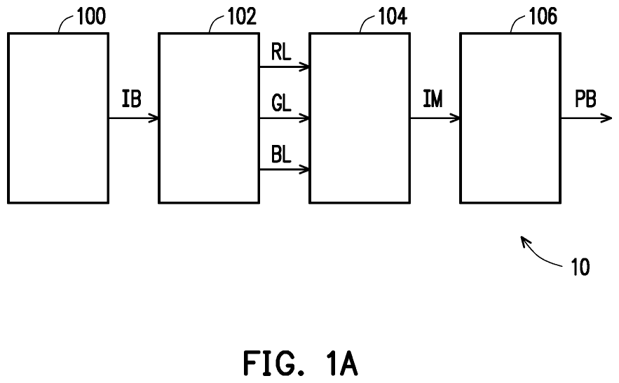

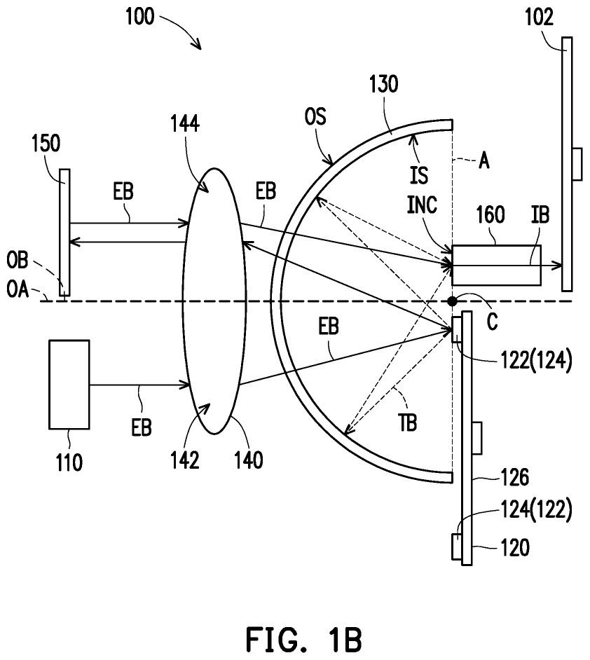

FIG. 1A is a block diagram of a projecting apparatus according to an embodiment of the present invention. Referring to FIG. 1A, the projecting apparatus 10 includes an illuminating system 100, a filter device 102, a light valve module 104 and an imaging lens 106. The illuminating system 100 is used for providing an illuminating beam IB. The filter device 102 is disposed on a transmission path of the illuminating beam IB and located between the illuminating system 100 and the light valve module 104. The filter device 102 is configured to divide the illuminating beam IB into a plurality of light beams in different colors, such as red light RL, blue light BL and green light GL. The light valve module 104 includes at least one light valve. In the present embodiment, the light valve module 104 is disposed on transmission paths of these light beams of different colors converted from the illuminating beam IB to convert these light beams of different colors into image beams IM. The imaging lens 106 is disposed on transmission paths of the image beams IM, receives the image beams IM, and provides projecting beams PB to a screen (not shown) for viewing by a viewer.

FIG. 1B is a diagram of an illuminating system according to an embodiment of the present invention. Referring to FIG. 1B, the illuminating system 100 is applicable to the projecting apparatus 10 of FIG. 1A. The illuminating system 100 includes a first light emitting module 110, a wavelength conversion device 120, a spherical-shell-shaped dichroic device 130, a light focusing lens group 140, a light relay unit 150 and a light homogenizing device 160. In FIG. 1B, the filter device 102 is a color filter wheel and receives the illuminating beam IB from the light homogenizing device 160.

The first light emitting module 110 includes at least one laser light source used for emitting an exciting beam EB. In the present embodiment, the exciting beam EB emitted by the first light emitting module 110 is a blue beam. The light focusing lens group 140 is disposed on a transmission path of the exciting beam EB, and used for guiding the exciting beam EB to the wavelength conversion device 120.

The wavelength conversion device 120 is disposed on the transmission path of the exciting beam EB, and has a wavelength conversion region 122 and a reflection region 124. The wavelength conversion region 122 is used for converting the exciting beam EB into a converted beam TB, wherein a wavelength of the converted beam TB is greater than a wavelength of the exciting beam EB, for example, the exciting beam EB is blue light, and the converted beam TB is yellow light, red light or green light. The reflection region 124 is used for reflecting the exciting beam EB.

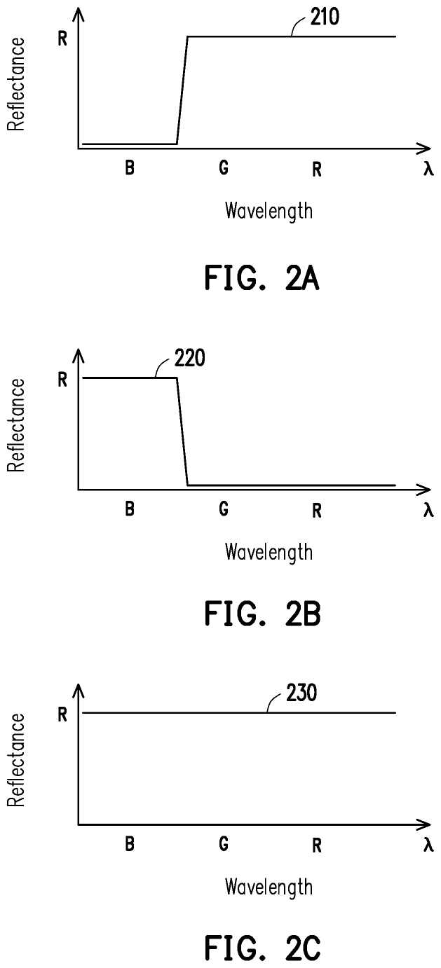

FIG. 2A is a diagram of reflectance of a spherical-shell-shaped dichroic device versus incident wavelengths according to an embodiment of the present invention. Referring to FIG. 2A, a curve 210 refers to a reflectance of the spherical-shell-shaped dichroic device 130 with wavelengths of an incident beam. The spherical-shell-shaped dichroic device 130 is disposed between the first light emitting module 110 and the wavelength conversion device 120. The spherical-shell-shaped dichroic device 130 has wavelength selectivity that may allow the exciting beam EB (blue light herein) to penetrate and reflect the converted beam TB (for example, yellow light, red light or green light). The converted beam TB reflected by the spherical-shell-shaped dichroic device 130 converges on a light incident surface INC of the light homogenizing device 160. The exciting beam EB reflected by the reflection region 124 may penetrate the spherical-shell-shaped dichroic device 130 again and is guided to the light relay unit 150.

FIG. 2B to FIG. 2C are diagrams of reflectance of a light relay unit versus incident wavelengths according to an embodiment of the present invention. In the present embodiment, the light relay unit 150 may be a light splitting element (reflectance as shown by curve 220 in FIG. 2B), or a reflective layer or reflective mirror (reflectance as shown by curve 230 in FIG. 2C), and is used for changing a direction of the exciting beam EB such that the exciting beam EB re-enters the spherical-shell-shaped dichroic device 130 to converge onto the light incident surface INC of the light homogenizing device 160. The present invention does not limit the implementation manner of the light relay unit 150.

The light homogenizing device 160 has the light incident surface INC and is disposed on one side of the spherical-shell-shaped dichroic device 130 together with the wavelength conversion device 120 relative to the first light emitting module 110. Specifically, the spherical-shell-shaped dichroic device 130 has an inner side surface IS (a surface adjacent to a sphere center C) and an outer side surface OS, and the first light emitting module 110 is disposed on one side (hereinafter referred to as an outer side) of the spherical-shell-shaped dichroic device 130, adjacent to the outer side surface OS, and the light homogenizing device 160 and the wavelength conversion device 120 are disposed on the opposite side (hereinafter referred to as an inner side) of the spherical-shell-shaped dichroic device 130, adjacent to the inner side surface IS.

The light relay unit 150 and the first light emitting module 110 are both disposed on the outer side of the spherical-shell-shaped dichroic device 130. However, based on an optical axis OA of the spherical-shell-shaped dichroic device 130, the light relay unit 150 and the first light emitting module 110 are respectively disposed on two opposite sides of the outer side of the spherical-shell-shaped dichroic device 130. In the embodiment of FIG. 1B, the first light emitting module 110 is disposed on a lower side of the outer side of the spherical-shell-shaped dichroic device 130, and the light relay unit 150 is disposed on an upper side of the outer side of the spherical-shell-shaped dichroic device 130. The light relay unit 150 reflects the exciting beam EB such that the exciting beam EB penetrates the spherical-shell-shaped dichroic device 130 once more (for the third time in the present embodiment) and converges onto the light incident surface INC of the light homogenizing device 160. The exciting beam EB and the converted beam TB pass through the light homogenizing device 160 to form the illuminating beam IB. The light homogenizing device 160 is, for example, an integration rod for homogenizing light rays. In the embodiment of FIG. 1B, the light homogenizing device 160 is disposed between the spherical-shell-shaped dichroic device 130 and the filter device 102.

The above elements will be explained in detail in the following sections.

In the present embodiment, the spherical-shell-shaped dichroic device 130 presents a shape of a part of a complete spherical shell having no notches or holes on its surface, the exciting beam EB may directly penetrate the spherical-shell-shaped dichroic device 130 without passing through the holes or slits on the surface of the spherical-shell-shaped dichroic device 130. In an embodiment, the spherical-shell-shaped dichroic device 130 is formed by conformally coating or attaching a dichroic filter onto a surface of a spherical-shell-type transparent substrate, but is not limited thereto.

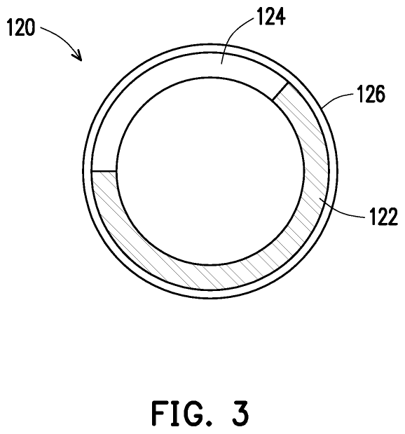

FIG. 3 is a diagram of a wavelength conversion device according to an embodiment of the present invention. Referring to FIG. 3 in conjunction with FIG. 1B, the wavelength conversion device 120 is a phosphor wheel, but is not limited thereto. The wavelength conversion device 120 includes a first rotation wheel 126, and a wavelength conversion region 122 and a reflection region 124 disposed on a surface of the first rotation wheel 126. The wavelength conversion unit 122 and the reflection region 124 are configured in a continuous annular shape on the first rotation wheel 126. Specifically, in the present embodiment, the wavelength conversion unit 122 and the reflection region 124 may cover the first rotation wheel 126 to form a complete ring, and the wavelength conversion unit 122 and the reflection region 124 are both continuously distributed without interruption.

When the first rotation wheel 126 rotates, the exciting beam EB may be alternately irradiated on the wavelength conversion unit 122 and the reflection region 124. The wavelength conversion region 122 has a photoluminescent material that may receive a short-wavelength beam and produce a corresponding converted beam TB by a photoluminescence phenomenon (as shown in FIG. 1B). The photoluminescent material is, for example, a phosphor, a type of the phosphor is, for example, a yellow phosphor, and the present invention is not limited thereto. When the photoluminescent material is a yellow light phosphor, the converted beam TB is correspondingly a yellow beam.

In the embodiment of FIG. 1B, a position where the wavelength conversion device 120 receives the exciting beam EB is a first position, the light incident surface INC of the light homogenizing device 160 is located at a second position, and the first position and the second position are mutually conjugate positions based on a sphere center C of the spherical-shell-shaped dichroic device 130.

In the present embodiment, the wavelength conversion region 122 is coplanar with the sphere center C of the spherical-shell-shaped dichroic device 130, and the light incident surface INC of the light homogenizing device 160 is also coplanar with the wavelength conversion region 122. Specifically, an extending plane of the wavelength conversion region 122 is a plane A, and when the sphere center C is also on the plane A, the light incident surface INC of the light homogenizing device 160 is also disposed on the plane A, i.e., coplanar. However, the present invention is not limited thereto.

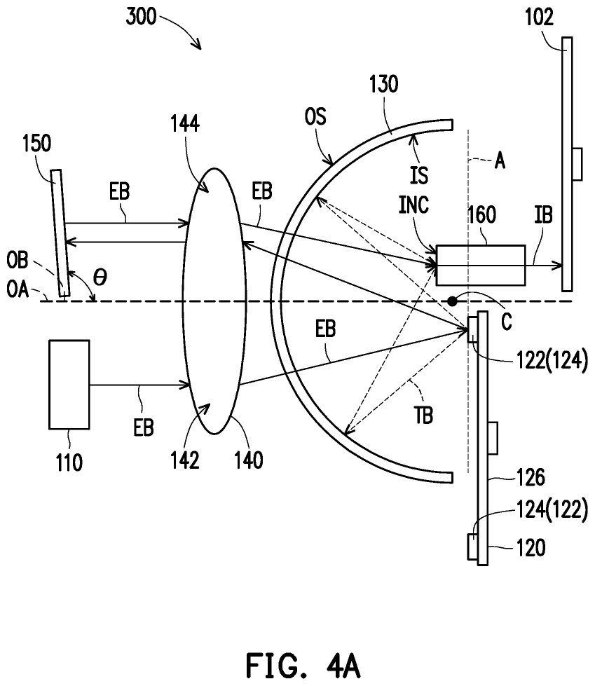

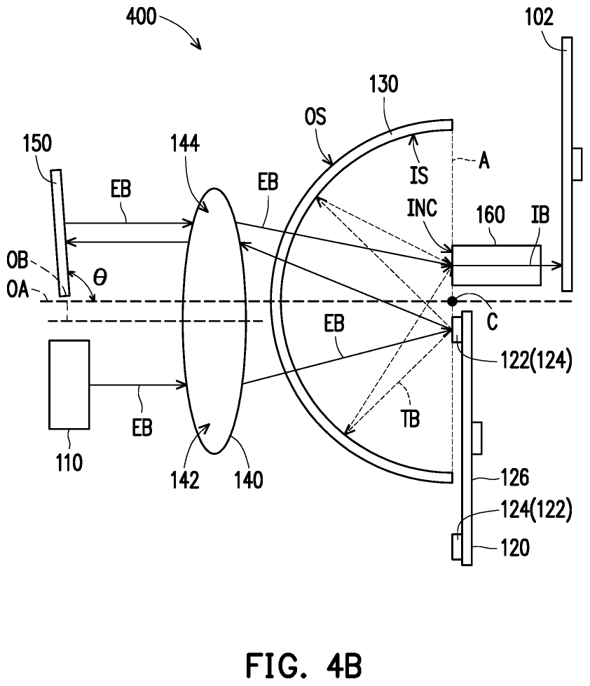

FIG. 4A is a diagram of an illuminating system according to another embodiment of the present invention. In the embodiment of FIG. 4A, the structure and implementation manner of an illuminating system 300 are similar to those of the illuminating system 100 of FIG. 1B, with the difference that in the embodiment of FIG. 4A, the wavelength conversion region 122 is not coplanar with the sphere center C of the spherical-shell-shaped dichroic device 130 C, and the light incident surface INC of the light homogenizing device 160 is not coplanar with the wavelength conversion region 122 either. In detail, when the sphere center C of the spherical-shell-shaped dichroic device 130 is not on the plane A, the light incident surface INC is not on the plane A either, but based on the sphere center C, the light incident surface INC and the wavelength conversion region 122 are at conjugate positions with respect to each other.

Referring to the embodiment of FIG. 1B again, the light focusing lens group 140 has a first region 142 and a second region 144. For example, with the optical axis OA of the spherical-shell-shaped dichroic device 130 as a boundary (in the present embodiment, the optical axis OA of the spherical-shell-shaped dichroic device 130 coincides with (is coaxial with) an optical axis OB of the light focusing lens group 140), a lower part of the light focusing lens group 140 is referred to as the first region 142, and an upper part of the light focusing lens group 140 is referred to as the second region 144, but the present invention does not limit the region size and definition manner of the first region 142 and the second region 144.

The exciting beam EB from the first light emitting module 110 passes through the first region 142 and penetrates the spherical-shell-shaped dichroic device 130 to irradiate the wavelength conversion device 120, the exciting beam EB is reflected by the wavelength conversion device 120, then penetrates the spherical-shell-shaped dichroic device 130, passes through the second region 144 and is guided to the light relay unit 150, and the light relay unit 150 reflects the exciting beam EB such that the exciting beam EB passes through the second region and the spherical-shell-shaped dichroic device 130 again and converges on the light incident surface INC of the light homogenizing device 160.

In the embodiment of FIG. 1, the optical axis OA of the spherical-shell-shaped dichroic device 130 coincides with the optical axis OB of the light focusing lens group 140, and an arrangement direction of the light relay unit 150 is perpendicular to the optical axis OA (or optical axis OB), i.e., a reflective surface of the light relay unit 150 is perpendicular to the optical axis OA (or optical axis OB) or an optical axis of the light relay unit 150 is parallel to the optical axis OA (or optical axis OB). However, the optical axes of the spherical-shell-shaped dichroic device 130 and the light focusing lens group 140 may not coincide (be not coaxial), and the arrangement direction of the light relay unit 150 may also be not perpendicular to the optical axis OA (or optical axis OB), i.e., the reflective surface of the light relay unit 150 and the optical axis OA (or optical axis OB) have an included angle or the optical axis of the light relay unit 150 is not parallel to the optical axis OA (or optical axis OB), which is not limited in the present invention. In an embodiment, it could be based on the positions of the wavelength conversion device 120 and the light homogenizing device 160 to determine whether the optical axis OA and the optical axis OB are to be coaxial, or the included angle between the light relay unit 150 and the optical axis OA (or optical axis OB).

FIG. 4B is a diagram of an illuminating system according to another embodiment of the present invention. In the embodiment of FIG. 4B, the structure and implementation manner of an illuminating system 400 are similar to those of the illuminating system 100 of FIG. 1, with the difference that in the embodiment of FIG. 4, the optical axis OA of the spherical-shell-shaped dichroic device 130 does not coincide with the optical axis OB of the light focusing lens group 140, the arrangement direction of the light relay unit 150 is not perpendicular to the optical axis OA (or optical axis OB), and there is an included angle θ between the reflective surface of the light relay unit 150 and the optical axis OA (or optical axis OB). The included angle θ between the light relay unit 150 and the optical axis OA is adjusted to change a reflection direction of the exciting beam EB, so that the exciting beam EB converges to the desired position via the light focusing lens group 140.

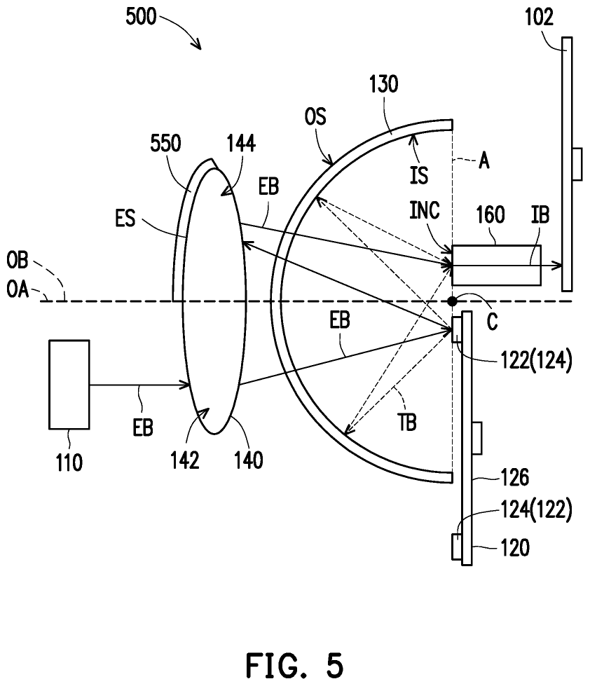

FIG. 5 is a diagram of an illuminating system according to another embodiment of the present invention. In the embodiment of FIG. 5, the structure and implementation manner of an illuminating system 500 are similar to those of the illuminating system 100 of FIG. 1B, with the difference that in the embodiment of FIG. 1B, the light relay unit 150 is a reflective mirror, but in the embodiment of FIG. 5, the light relay unit 550 is a reflective layer disposed on a light emergent surface ES of the second region 144, wherein the light emergent surface ES of the second region 144 refers to a surface of the light focusing lens group 140, that is farthest from the spherical-shell-shaped dichroic device 130.

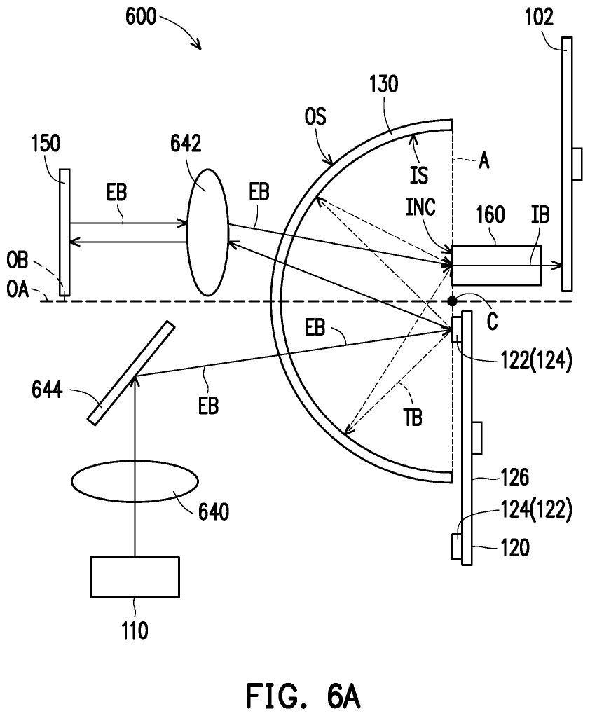

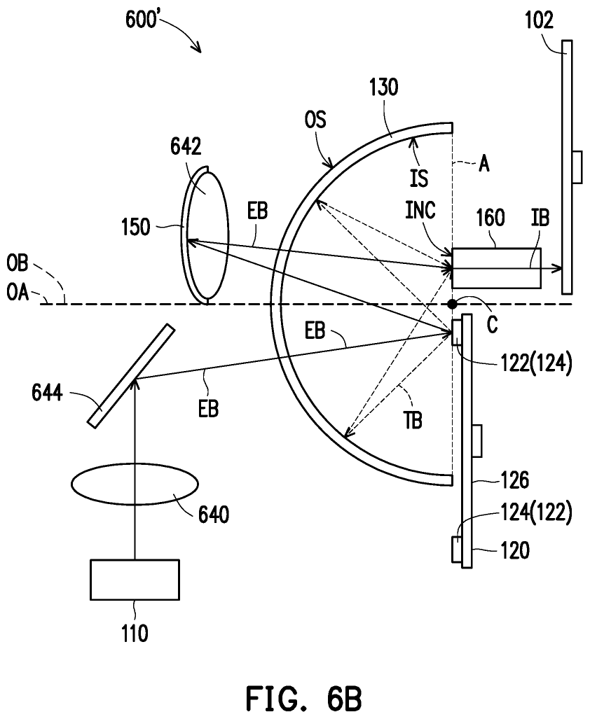

FIG. 6A is a diagram of an illuminating system according to another embodiment of the present invention. In the embodiment of FIG. 6A, an illuminating system 600 is similar to the illuminating system 100 of FIG. 1B, but the illuminating system 600 uses a first light focusing lens group 640 and a second light focusing lens group 642 instead of the light focusing lens group 140 in FIG. 1. The first light focusing lens group 640 is disposed on a path of the exciting beam EB between the first light emitting module 110 and the spherical-shell-shaped dichroic device 130. The second light focusing lens group 642 is disposed on a path of the exciting beam EB between the light relay unit 150 and the spherical-shell-shaped dichroic device 130. The exciting beam EB reflected by the wavelength conversion device 120 passes through the second light focusing lens group 642 and is transmitted to the light relay unit 150. The light relay unit 150 reflects the exciting beam EB such that the exciting beam EB passes through the second light focusing lens group 642 and the spherical-shell-shaped dichroic device 130 once more and converges on the light incident surface INC of the light homogenizing device 160.

In the present embodiment, the illuminating system 600 further includes a reflective mirror 644. The reflective mirror 644 is disposed on a path of the exciting beam EB between the first light focusing lens group 640 and the spherical-shell-shaped dichroic device 130, and configure to change the direction of the exciting beam EB such that the exciting beam EB enters the spherical-shell-shaped dichroic device 130.

FIG. 6B is a diagram of an illuminating system according to another embodiment of the present invention. In the embodiment of FIG. 6B, an illuminating system 600′ is similar to the illuminating system 600 of FIG. 6A, but the light relay unit 150 may be a reflective layer disposed on the light emergent surface of the second light focusing lens group 642, wherein the light emergent surface of the second light focusing lens group 642 refers to a surface of the second light focusing lens group 642, that is farthest from the spherical-shell-shaped dichroic device 130. For the implementation manner of the embodiment, reference may be made to the embodiment of FIG. 5 or FIG. 6A, and the descriptions thereof are omitted herein.

It should be noted that the reflective mirror 644 of the illuminating system 600 or illuminating system 600′ is not necessary. In other embodiments, the illuminating system may not include the reflective mirror 644, the exciting beam EB emitted by the first light emitting module 110 may directly penetrate the first light focusing lens group 640 and the spherical-shell-shaped dichroic device 130, or the first light focusing lens group 640 is disposed between the reflective mirror 644 and the spherical-shell-shaped dichroic device 130. The present invention does not limit the arrangement positions of the reflective mirror 644 and the first light focusing lens group 640.

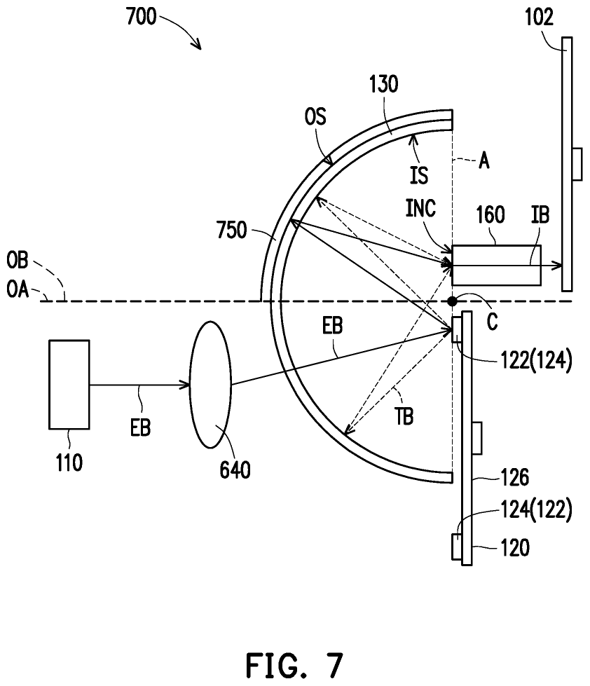

FIG. 7 is a diagram of an illuminating system according to another embodiment of the present invention. In the embodiment of FIG. 7, the structure and implementation manner of an illuminating system 700 are similar to those of the illuminating system 600 of FIG. 6A, but a light relay unit 750 of the illuminating system 700 is a reflective layer and is disposed on an outer side surface OS of the spherical-shell-shaped dichroic device 130. The light relay unit 750 may be configured as a reflective film on the outer side surface OS in a coating or a reflection cover attached to the outer side surface OS, which is not limited in the present invention. Specifically, the light relay unit 750 only covers a part of the spherical-shell-shaped dichroic device 130, and herein, the light relay unit 750 only covers an upper part of the spherical-shell-shaped dichroic device 130 (with the optical axis OA as a boundary). The exciting beam EB from the first light focusing lens group 640 may penetrate a lower part of the uncovered spherical-shell-shaped dichroic device 130 to irradiate the wavelength conversion device 120. The exciting beam EB reflected by the wavelength conversion device 120 may be directly reflected by the light relay unit 750 covering the upper part after penetrating the spherical-shell-shaped dichroic device 130, so as to converge to the light incident surface INC of the light homogenizing device 160. In the present embodiment, the illuminating system 700 may also omit the second light focusing lens group 642 as compared with the illuminating system 600.

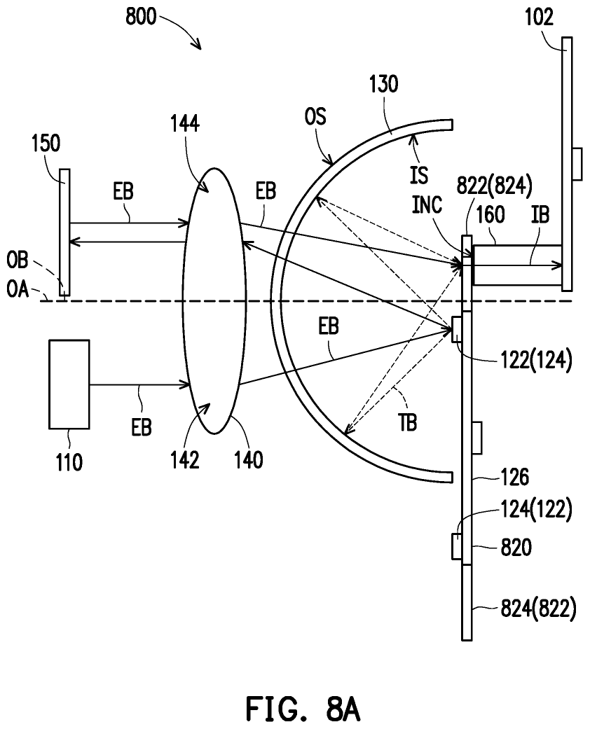

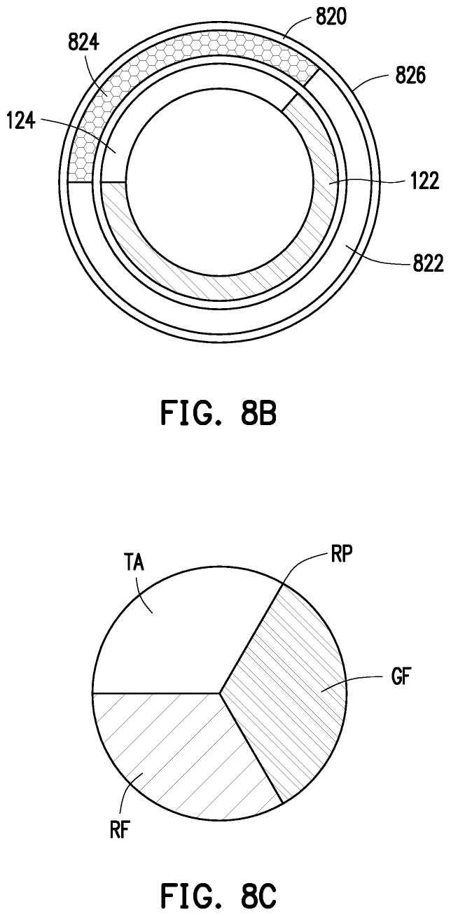

FIG. 8A is a diagram of an illuminating system according to another embodiment of the present invention. FIG. 8B is a diagram of a wavelength conversion device according to another embodiment of the present invention. In the embodiment of FIG. 8A, the structure and implementation manner of an illuminating system 800 are similar to those of the illuminating system 100 of FIG. 1, but the illuminating system 800 uses a wavelength conversion device 820 instead of the wavelength conversion device 120, and FIG. 8B shows a structure diagram of the wavelength conversion device 820.

The wavelength conversion device 820 is disposed between the spherical-shell-shaped dichroic device 130 and the light homogenizing device 160. Compared with the wavelength conversion device 120, the wavelength conversion device 820 further includes a first light penetration region 822 and a light scattering region 824, wherein the first light penetration region 822 and the light scattering region 824 are respectively configured in an outermost annular region of a first rotation wheel 826 corresponding to the wavelength conversion region 122 and the reflection region 124. The first light penetration region 822 is used for allowing the converted beam TB to penetrate, and disposed on a periphery of the wavelength conversion region 122. The light scattering region 824 is used for allowing the exciting beam EB to penetrate and scattering the exciting beam EB, and disposed on a periphery of the reflection region 124. In detail, the first light penetration region 822 and the wavelength conversion region 122 have the same arc angle and belong to the same sector region. Similarly, the light scattering region 824 and the reflection region 124 also have the same arc angle, and belong to the same section region.

It should be noted that when the first rotation wheel 826 rotates, the wavelength conversion region 122 and the reflection region 124 cannot overlap with the light incident surface INC. However, in the present embodiment, when the first rotation wheel 826 rotates, the first light penetration region 822 and the light scattering region 824 may alternately cover the light incident surface INC, the converted beam TB may pass through the first light penetration region 822 and enters the light homogenizing device 160, and the exciting beam EB may pass through the light scattering region 824 and enters the light homogenizing device 160.

FIG. 8C is a diagram of a filter device of FIG. 8A according to the present invention. The illuminating system 800 is applicable to a projecting apparatus. In the embodiment of FIG. 8A, the filter device 102 is disposed behind the light emergent surface of the light homogenizing device 160 along an optical axis direction of the illuminating beam IB, wherein the light emergent surface of the light homogenizing device 160 is relative to the light incident surface INC. The illuminating beam IB exiting from the light emergent surface of the light homogenizing device 160 may pass through the filter device 102 to produce a plurality of light beams in different colors. In the present embodiment, the filter device 102 includes a second rotation wheel RP, a filter region (a red filter region RF and a green filter region GF in FIG. 8C) and a second light penetration region TA. The filter region may divide the illuminating beam IB into a plurality of light beams of different colors, for example, the illuminating beam IB passes through the red filter region RF to produce a red beam, and the illuminating beam IB passes through the green filter region GF to produce a green beam. The second light penetration region TA is used for allowing the illuminating beam IB to penetrate. The filter region (red filter region RF and green filter region GF) and the second light penetration region TA are annularly arranged on the second rotation wheel RP, and the arrangement positions and the arc angles thereof may correspond to a configuration of the wavelength conversion region 122 and the reflection region 124 of the wavelength conversion device 820 on the first rotation wheel 826.

Specifically, an arc angle of the filter region of the filter device 102 at the second rotation wheel RP may be the same as an arc angle of the wavelength conversion region 122 of the wavelength conversion device 820 on the first rotation wheel 826; an arc angle of the second light penetration region TA of the filter device 102 on the second rotation wheel RP may be the same as an arc angle of the reflection region 124 of the wavelength conversion device 820 on the first rotation wheel 826. In addition, the arrangement of the filter region and the second light penetration region TA on the second rotation wheel RP may also be the same as the arrangement of the wavelength conversion region 122 and the reflection region 124 on the first rotation wheel 826.

In addition, the second rotation wheel RP of the filter device 102 may rotate in synchronization with the first rotation wheel 826 of the wavelength conversion device 820. That is, when the exciting beam EB converges to the wavelength conversion region 122, the first light penetration region 822 covers the light incident surface INC of the light homogenizing device 160, and therefore, the converted beam TB enters the light homogenizing device 160 through the first light penetration region 822. At this time, the filter region of the filter device 102 may be turned to the light emergent surface of the light homogenizing device 160, and the illuminating beam IB generates red light or green light through the red filter region RF or the green filter region GF. On the other hand, when the exciting beam EB converges to the reflection region 124, the light scattering region 824 covers the light incident surface INC of the light homogenizing device 160, causing the exciting beam EB to enter the light homogenizing device 160 through the light scattering region 824. At this time, the second light penetration region TA of the filter device 102 is turned to the light emergent surface of the light homogenizing device 160 to allow the illuminating beam IB to pass through.

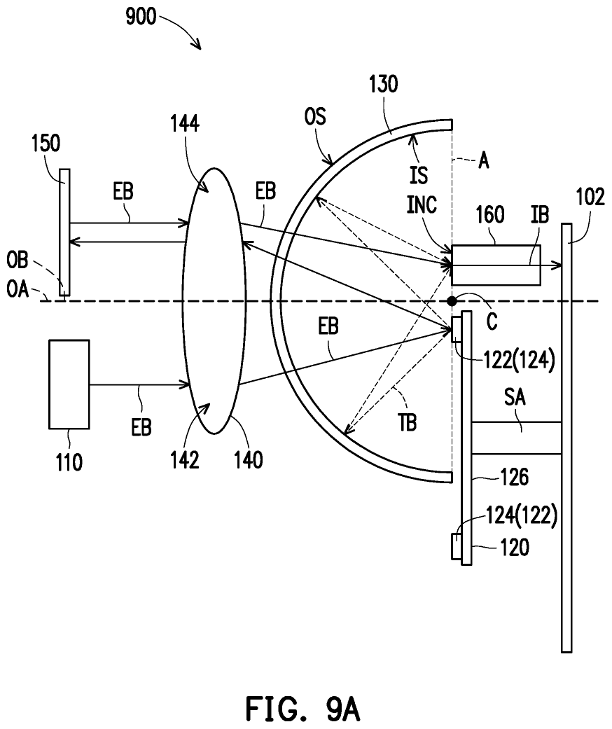

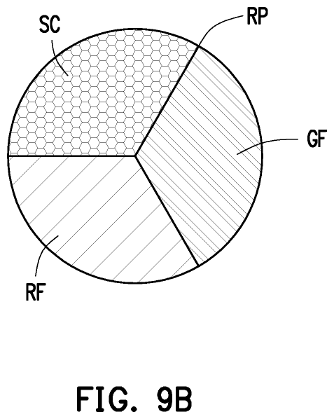

FIG. 9A is a diagram of an illuminating system according to another embodiment of the present invention. An illuminating system 900 is similar to the illuminating system 100, and the illuminating system 900 is also applicable to a projecting apparatus. In the embodiment of FIG. 9A, the structure of the wavelength conversion device 120 may refer to FIG. 3. Being disposed behind the light emergent surface of the light homogenizing device 160 along the optical axis direction of the illuminating beam IB, the filter device 102 receives the illuminating beam IB from the light homogenizing device 160 to produce a plurality of light beams in different colors.

FIG. 9B is a diagram of a filter device of FIG. 9A according to the present invention. In the present embodiment, the filter device 102 includes a second rotation wheel RP, a filter region (a red filter region RF and a green filter region GF in FIG. 8C) and an illuminating light scattering region SC. The illuminating beam IB passes through the red filter region RF to produce a red beam, and the illuminating beam IB passes through the green filter region GF to produce a green beam. The illuminating light scattering region SC is used for scattering the illuminating beam IB. The filter region and the illuminating light scattering region SC are disposed on the second rotation wheel RP respectively corresponding to the positions of the wavelength conversion region 122 and the reflection region 124 on the first rotation wheel 126.

In addition, in the present embodiment, the first rotation wheel 126 of the wavelength conversion device 120 and the second rotation wheel RP of the filter device 102 share a rotating axis SA, and therefore, the first rotation wheel 126 and the second rotation wheel RP may rotate synchronously.

Specifically, an arc angle of the filter region of the filter device 102 on the second rotation wheel RP may be the same as an arc angle of the wavelength conversion region 122 of the wavelength conversion device 120 on the first rotation wheel 126; and an arc angle of the illuminating light scattering region SC on the second rotation wheel RP is the same as an arc angle of the reflection region 124 of the wavelength conversion device 120 on the first rotation wheel 126. Further, the arrangement positions of the filter region and the illuminating light scattering region SC on the second rotation wheel RP may be the same as the arrangement positions of the wavelength conversion region 122 and the reflection region 124 on the first rotation wheel 126 (with the rotating axis SA as an axis).

When the exciting beam EB converges to the wavelength conversion region 122, the filter region of the filter device 102 may be turned to the light emergent surface of the light homogenizing device 160, and the illuminating beam IB generates red light or green light through the red filter region RF or the green filter region GF. When the exciting beam EB converges to the reflection region 124, the illuminating light scattering region SC of the filter device 102 may be turned to the light emergent surface of the light homogenizing device 160, so as to allow the illuminating beam IB to pass through and scatter the illuminating beam IB.

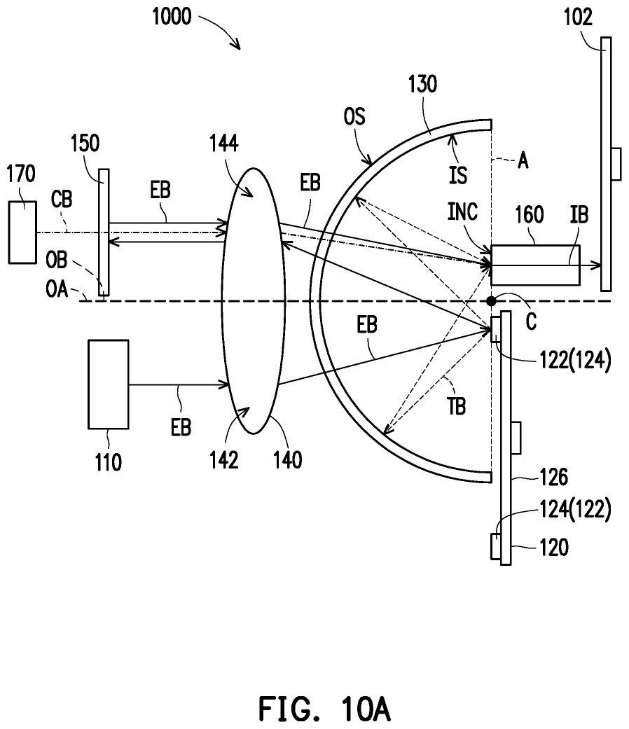

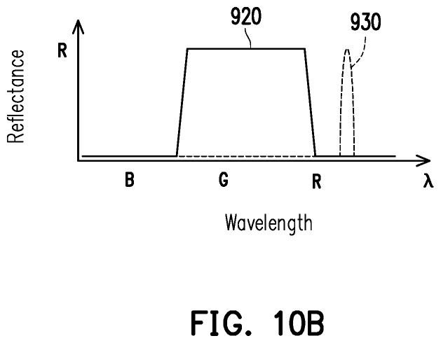

FIG. 10A is a diagram of an illuminating system according to another embodiment of the present invention. Referring to FIG. 10A, compared with the illuminating system 100, an illuminating system 1000 further includes a second light emitting module 170. The second light emitting module 170 is configured to emit an auxiliary beam CB, and a wavelength of the auxiliary beam CB is different from a wavelength of the exciting beam EB. For example, the exciting beam EB is blue light, and the auxiliary beam CB is a red light. Both the second light emitting module 170 and the first light emitting module 110 are disposed on the outer side of the spherical-shell-shaped dichroic device 130, but the second light emitting module 170 is disposed, relative to the first light emitting module 110, on another side of the outer side of the spherical-shell-shaped dichroic device 130 together with the light relay unit 150. The second light emitting module 170 is disposed on the upper side of the outer side of the spherical-shell-shaped dichroic device 130 in FIG. 10A together with the light relay unit 150.

Specifically, in the present embodiment, the light relay unit 150 is a light splitter, and is adapted to allow the auxiliary beam CB to penetrate, and is also adapted to reflect the exciting beam EB.

FIG. 10B is a diagram of reflectance of a spherical-shell-shaped dichroic device of FIG. 10A versus incident wavelengths according to the present invention. The reflectance of the spherical-shell-shaped dichroic device 130 may be adjusted according to the wavelength of the auxiliary beam CB. Referring to FIG. 10B, a curve 920 represents the reflectance of the spherical-shell-shaped dichroic device 130 with the incident wavelength, and a curve 930 is a spectrum of the auxiliary beam CB. Therefore, the auxiliary beam CB may penetrate the light relay unit 150 and the spherical-shell-shaped dichroic device 130 and converge on the light incident surface of the light homogenizing device 160.

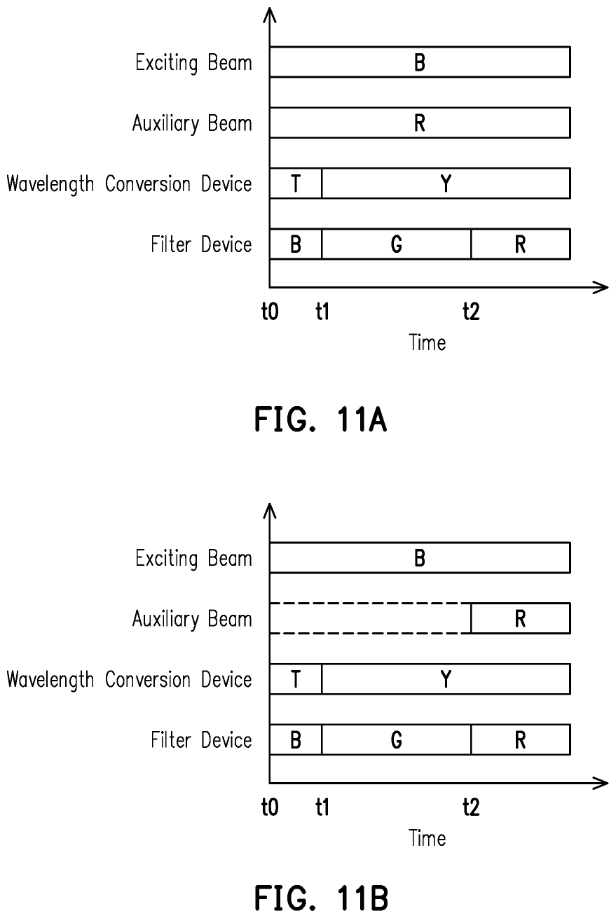

FIG. 11A is an incidence beam sequence diagram for a wavelength conversion device and a filter device of FIG. 10A according to the present invention. The structure of the filter device 102 may refer to FIG. 8C or FIG. 9B, and the present invention does not limit the implementation form of the filter device 102. Herein, the embodiment of FIG. 9B will be described as an example.

During the process, both the exciting beam EB and the auxiliary beam CB continuously enter the light homogenizing device 160 (an interval B of the exciting beam and an interval R of the auxiliary beam), and between time t0 and time t1, the exciting beam EB converges on the reflection region 124 of the wavelength conversion device 120 (an interval T of the wavelength conversion device), and the illuminating light scattering region SC of the filter device 102 is turned to cover the light emergent surface of the light homogenizing device 160 (mainly for scattering the exciting beam EB) (an interval B of the filter device). After time t1, the exciting beam EB converges on the wavelength conversion region 122 of the wavelength conversion device 120 (an interval Y of the wavelength conversion device) to produce a converted beam TB (taking yellow light as an example). Between time t1 and time t2, the green filter region GF of the filter device 102 may be turned to the light emergent surface of the light homogenizing device 160 (an interval G of the filter device) to produce green light. After time t2, the red filter region RF of the filter device 102 may be turned to the light emergent surface of the light homogenizing device 160 (an interval R of the filter device) to produce red light.

FIG. 11B is another incidence beam sequence diagram for the wavelength conversion device and the filter device of FIG. 10A according to the present invention. The embodiment of FIG. 11B and the embodiment of FIG. 11A have a similar implementation manner, with the difference that the auxiliary beam CB does not need to enter the light homogenizing device 160 continuously. Taking the auxiliary beam CB as red light as an example, the auxiliary beam CB may be provided only after time t2 to achieve an energy saving effect. For detailed implementation manners, sufficient teaching and advice may be obtained from the description of the above embodiments, and the descriptions thereof are omitted herein.

In the present embodiment, a light valve included in the light valve module 104 in the projecting apparatus refers to any one of pace light modulators, such as a digital micro-mirror device (DMD), a liquid-crystal-on-silicon panel (LPOS panel), or liquid crystal panel (LCD) or the like, which is not limited in the present invention.

In addition, it should be noted that, in another embodiment, the filter device 102 of the projecting apparatus 10 may perform light splitting by a prism group, and the present invention does not limit the implementation form of the filter device 102. For detailed steps and implementation manners regarding how to use the light splitter and combiner lens group to receive the illuminating beam for light splitting, sufficient teaching, advice and implementation instructions may be obtained from the ordinary knowledge in the art, and the descriptions thereof are omitted herein.

Based on the above, the exemplary embodiments of the present invention provide an illuminating system and a projecting apparatus, and the projecting apparatus includes the above-mentioned illuminating system. The illuminating system includes a first light emitting module, a wavelength conversion device, a spherical-shell-shaped dichroic device, a light homogenizing device and a light relay unit. The wavelength conversion device may convert the exciting beam emitted by the first light emitting module into the converted beam. In the present embodiment, the splitting characteristic of the spherical-shell-shaped dichroic device is adopted. The spherical-shell-shaped dichroic device is configured to allow the exciting beam to penetrate and also configured to reflect the converted beam. The converted beam may converge on the light homogenizing device, and the reflected exciting beam penetrating the spherical-shell-shaped dichroic device may be guided by the light relay unit and re-converge to the light homogenizing device, wherein the exciting beam and the converted beam pass through the light homogenizing device to form the illuminating beam. Therefore, the illuminating system and the projecting apparatus according to the embodiments of the present invention have a simple structure, and may reduce the system volume and enhance the system efficiency.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illuminating system, comprising a first light emitting module, a wavelength conversion device, a spherical-shell-shaped dichroic device, a light homogenizing device and a light relay unit, wherein
the first light emitting module is configured to emit an exciting beam;
the wavelength conversion device is disposed on a transmission path of the exciting beam, and comprises a wavelength conversion region and a reflection region, wherein the wavelength conversion region is configured to convert the exciting beam into a converted beam, wherein a wavelength of the converted beam is greater than a wavelength of the exciting beam, and the reflection region is configured to reflect the exciting beam;
the spherical-shell-shaped dichroic device is disposed between the first light emitting module and the wavelength conversion device, and the spherical-shell-shaped dichroic device is configured to allow the exciting beam to penetrate and to reflect the converted beam;
the light homogenizing device is disposed on one side of the spherical-shell-shaped dichroic device together with the wavelength conversion device relative to the first light emitting module, and the light homogenizing device comprises a light incident surface, wherein the converted beam reflected by the spherical-shell-shaped dichroic device converges on the light incident surface; and
based on an optical axis of the spherical-shell-shaped dichroic device, the light relay unit and the first light emitting module are respectively disposed on two sides of an outer side of the spherical-shell-shaped dichroic device,
wherein the exciting beam reflected by the wavelength conversion device penetrates the spherical-shell-shaped dichroic device and is transmitted to the light relay unit, and the light relay unit reflects the exciting beam such that the exciting beam re-penetrates the spherical-shell-shaped dichroic device and converges on the light incident surface of the light homogenizing device, and
wherein the exciting beam and the converted beam pass through the light homogenizing device to form an illuminating beam.

2. The illuminating system according to claim 1, wherein a position where the wavelength conversion device receives the exciting beam is a first position, the light incident surface of the light homogenizing device is located at a second position, and the first position and the second position are mutually conjugate positions based on a sphere center of the spherical-shell-shaped dichroic device.

3. The illuminating system according to claim 1, wherein the spherical-shell-shaped dichroic device presents a shape of a part of a complete spherical shell.

4. The illuminating system according to claim 1, further comprising a light focusing lens group, wherein
the light focusing lens group is disposed on the transmission path of the exciting beam, and comprises a first region and a second region, wherein the exciting beam from the first light emitting module passes through the first region and penetrates the spherical-shell-shaped dichroic device to irradiate the wavelength conversion device, the exciting beam is reflected by the wavelength conversion device, then passes through the second region and is guided to the light relay unit, and the light relay unit reflects the exciting beam such that the exciting beam passes through the second region and the spherical-shell-shaped dichroic device again and converges on the light incident surface of the light homogenizing device.

5. The illuminating system according to claim 4, wherein an optical axis of the light focusing lens group coincides with or does not coincide with the optical axis of the spherical-shell-shaped dichroic device.

6. The illuminating system according to claim 4, wherein the light relay unit is a reflective layer disposed on a light emergent surface of the second region, and the light emergent surface of the second region refers to a surface of the light focusing lens group, that is farthest from the spherical-shell-shaped dichroic device.

7. The illuminating system according to claim 1, further comprising a first light focusing lens group and a second light focusing lens group, wherein
the first light focusing lens group is disposed on a path of the exciting beam between the first light emitting module and the spherical-shell-shaped dichroic device; and
the second light focusing lens group is disposed on a path of the exciting beam between the light relay unit and the spherical-shell-shaped dichroic device, and configured to guide the exciting beam reflected by the wavelength conversion device to the light relay unit, wherein the exciting beam reflected by the light relay unit passes through the second light focusing lens group and the spherical-shell-shaped dichroic device again and converges on the light incident surface of the light homogenizing device.

8. The illuminating system according to claim 7, further comprising a reflective mirror, wherein
the reflective mirror is disposed on a path of the exciting beam between the first light focusing lens group and the spherical-shell-shaped dichroic device, and configured to change a direction of the exciting beam such that the exciting beam enters the spherical-shell-shaped dichroic device.

9. The illuminating system according to claim 7, wherein the light relay unit is a reflective layer disposed on a light emergent surface of the second light focusing lens group, wherein the light emergent surface of the second light focusing lens group refers to a surface of the second light focusing lens group, that is farthest from the spherical-shell-shaped dichroic device.

10. The illuminating system according to claim 1, wherein the light relay unit is a reflective layer disposed on an outer side surface of the spherical-shell-shaped dichroic device.

11. The illuminating system according to claim 1, wherein when the wavelength conversion region and the sphere center of the spherical-shell-shaped dichroic device are coplanar, the light incident surface of the light homogenizing device and the wavelength conversion region are coplanar, and when the wavelength conversion region and the sphere center of the spherical-shell-shaped dichroic device are not coplanar, the light incident surface of the light homogenizing device and the wavelength conversion region are not coplanar.

12. The illuminating system according to claim 1, wherein the wavelength conversion device is disposed between the spherical-shell-shaped dichroic device and the light homogenizing device, the wavelength conversion device further comprises a light scattering region, a first light penetration region and a first rotation wheel,
the light scattering region is configured to allow the exciting beam to penetrate and to scatter the exciting beam; and
the first light penetration region is configured to allow the converted beam to penetrate,
wherein the wavelength conversion region and the reflection region are configured in a continuous annular shape on the first rotation wheel, the light scattering region and the first light penetration region are respectively configured in an outermost annular region of the first rotation wheel corresponding to the reflection region and the wavelength conversion region, and the light scattering region and the first light penetration region cover the light incident surface of the light homogenizing device when the first rotation wheel rotates.

13. The illuminating system according to claim 1, further comprising a second light emitting module, wherein
the second light emitting module is disposed, relative to the first light emitting module, on another side of the outer side of the spherical-shell-shaped dichroic device together with the light relay unit, and configured to emit an auxiliary beam, and a wavelength of the auxiliary beam is different from the wavelength of the exciting beam,
wherein the light relay unit is a light splitter, is configured to allow the auxiliary beam to penetrate and to reflect the exciting beam, and wherein the auxiliary beam penetrates the light relay unit and the spherical-shell-shaped dichroic device and converges on the light incident surface of the light homogenizing device.

14. A projecting apparatus, comprising an illuminating system, a light valve module and an imaging lens, wherein
the illuminating system comprises a first light emitting module, a wavelength conversion device, a spherical-shell-shaped dichroic device, a light homogenizing device and a light relay unit, wherein
the first light emitting module is configured to emit an exciting beam;
the wavelength conversion device is disposed on a transmission path of the exciting beam, and comprises a wavelength conversion region and a reflection region, wherein the wavelength conversion region is configured to convert the exciting beam into a converted beam, wherein a wavelength of the converted beam is greater than a wavelength of the exciting beam, and the reflection region is configured to reflect the exciting beam;
the spherical-shell-shaped dichroic device is disposed between the first light emitting module and the wavelength conversion device, and the spherical-shell-shaped dichroic device is configured to allow the exciting beam to penetrate and to reflect the converted beam;
the light homogenizing device is disposed on one side of the spherical-shell-shaped dichroic device together with the wavelength conversion device relative to the first light emitting module, and the light homogenizing device comprises a light incident surface, wherein the converted beam reflected by the spherical-shell-shaped dichroic device converges on the light incident surface; and
based on an optical axis of the spherical-shell-shaped dichroic device, the light relay unit and the first light emitting module are respectively disposed on two sides of an outer side of the spherical-shell-shaped dichroic device,
wherein the exciting beam reflected by the wavelength conversion device penetrates the spherical-shell-shaped dichroic device and is transmitted to the light relay unit, and the light relay unit reflects the exciting beam such that the exciting beam re-penetrates the spherical-shell-shaped dichroic device and converges on the light incident surface of the light homogenizing device, and wherein the exciting beam and the converted beam pass through the light homogenizing device to form an illuminating beam;
the light valve module is disposed on a transmission path of the illuminating beam, and converts the illuminating beam into at least one image beam; and
the imaging lens is disposed on a transmission path of the at least one image beam, and the at least one image beam is transmitted to the imaging lens to form a projecting beam.

15. The projecting apparatus according to claim 14, further comprising a filter device, wherein
the filter device is disposed on a transmission path of the illuminating beam, and configured to divide the illuminating beam into a plurality of light beams in different colors.

16. The projecting apparatus according to claim 15, wherein
the wavelength conversion device further comprises a first rotation wheel, wherein
the wavelength conversion region and the reflection region are configured in a continuous annular shape on the first rotation wheel; and
the filter device is disposed behind the wavelength conversion device along an optical axis direction of the illuminating beam, and comprises a filter region, an illuminating light scattering region and a second rotation wheel, wherein
the filter region is configured to divide the illuminating beam into the plurality of light beams in different colors;
the illuminating light scattering region is configured to scatter the illuminating beam; and
the second rotation wheel and the first rotation wheel share a rotating axis, wherein the filter region and the illuminating light scattering region are respectively configured on the second rotation wheel corresponding to the positions of the wavelength conversion region and the reflection region on the first rotation wheel.

17. The projecting apparatus according to claim 16, wherein when the second rotation wheel and the first rotation wheel rotate synchronously and the exciting beam is irradiated on the wavelength conversion region, the illuminating beam is irradiated on the filter region, and when the exciting beam is irradiated on the reflection region, the illuminating beam is irradiated on the illuminating light scattering region.

18. The projecting apparatus according to claim 14, wherein
the wavelength conversion device is disposed between the spherical-shell-shaped dichroic device and the light homogenizing device, and further comprises a light scattering region, a first light penetration region and a first rotation wheel, wherein
the light scattering region is configured to allow the exciting beam to penetrate and to scatter the exciting beam;
the first light penetration region is configured to allow the converted beam to penetrate,
wherein the wavelength conversion region and the reflection region are configured in a continuous annular shape on the first rotation wheel, the light scattering region and the first light penetration region are respectively configured in an outermost annular region of the first rotation wheel corresponding to the reflection region and the wavelength conversion region, and the light scattering region and the first light penetration region cover the light incident surface of the light homogenizing device when the first rotation wheel rotates; and
the filter device is disposed behind a light emergent surface of the light homogenizing device along the optical axis direction of the illuminating beam, and comprises a filter region, a second light penetration region and a second rotation wheel, wherein
the filter region is configured to divide the illuminating beam into a plurality of light beams in different colors;
the second light penetration region is configured to allow the illuminating beam to penetrate; and
the second rotation wheel and the first rotation wheel rotate synchronously, wherein the filter region and the second light penetration region are respectively configured on the second rotation wheel corresponding to the positions of the wavelength conversion region and the reflection region on the first rotation wheel.
